(19) United States
(12) Patent Application Publication
(10) Pub. No.: US 2023/0417189 A1
(43) Pub. Date: Dec. 28, 2023

(54) Ecosystem Risk Mitigation System

(71) Applicant: Gary Ross, Houston, TX (US)

(72) Inventor: Gary Ross, Houston, TX (US)

(21) Appl. No.: 18/460,538

(22) Filed: Sep. 2, 2023

Related U.S. Application Data
(63) Continuation-in-part of application No. 17/887,671, filed on Aug. 15, 2022.
Application No. 17/887,671 is a continuation of application No. 16/635,088, filed on Jan. 29, 2020, now Pat. No. 11,415,053.
(60) Provisional application No. 62/544,517, filed on Aug. 11, 2017.

(51) Int. Cl. F02C 7/20; E21B 41/00

(52) U.S. Cl. CPC F02C 7/20; E21B 41/0064; B01D 53/02

(57) ABSTRACT

An Ecosystem Risk Mitigation System comprehensive of Green Technology

### CROSS REFERENCE TO RELATED APPLICATION

This application is a continuation-in-part of U.S. application Ser. No. 17/887,671 filed Aug. 15, 2022, which in turn is a continuation of U.S. application Ser. No. 16/635,088 filed Jan. 29, 2020, which in turn is a national phase application of PCT/US2018/045713 filed Aug. 8, 2018, which in turn claims priority to U.S. Application No. 62/544,517 filed on 11 Aug. 2017, the disclosures of which are all incorporated herein by reference for all purposes.

### FIELD OF THE INVENTION

Green Technology: This application contains one or more claims to a product or process that mitigates climate change by being designed to reduce and/or prevent additional greenhouse gas emissions.

### BACKGROUND OF THE INVENTION

### Foreword in Religious Context

Dear Father, as you are aware the inhabitants of your creation have been adversely affecting the ecosystem with the byproducts of technology that has created the world we all live in today. We cannot change the past, but we pray to you to help understanding of the risk to our ecosystem and for implementation of the mitigation system foretold, by your decision makers. Established in America, the technology can then be shared on a global basis so we can sustain your creation. King James 1^{st} delivered to the world both your written word in the bible and a patent system. Coincidently we use said patent system to protect invention from corporate wealth creation, to enable structured technical mitigation of the ecosystem by many nations and sequential redemption of your biblical creation.

### Patent Intent

Teaching of technical advances in the Art to expand human knowledge. In essence, teach of the risk to our ecosystem to all: herein is written with minimum legalize in a report style, inclusive of both technical and non-technical background.

### Motivation of Inventive Concept

Further to consecutive natural disasters, use of my Skills in the Art to identify the worst case risk scenario associated with “The Climate Change Problem”, known to be caused by continuous anthropogenic emissions. Plan for the worst and pray for the best, with a technical solution that is a combination of technologies to enable near term mitigation and prevent the potential risk event being realized.

Using a risk perspective and working backwards identified non-technical problems swaying technical mitigations, recommendations to solve are inclusive.

The top contributor to the cause of “The Climate Change Problem”, is power generation from fossil fuel sources at 39% of global anthropogenic emissions. “The Problem” recognized in “The State of The Art” which teaches of an oceanic carbon neutral solution for Base Load Power Generation, using fossil fuel sources.

This inventive concept provides a solution to the “Problem of Losses”: Historically, base load power generation systems are located remote from coastal cities with high population and demand, i.e., New York. Transmission losses occur when supplying said coastal cities, and when losses are compensated by fossil fuel powered generation, this in turn produces more anthropogenic emissions and an unfortunate feedback loop, accepted as a nature of the business.

### Discovery of “the Climate Change Problem”

1820s Joseph Fourier, the first person to study the Earth's temperature from a mathematical perspective. He advised of the “possibility that the Earth's atmosphere might act as an insulator” widely recognized as the greenhouse effect.
1856 Eunice Foote, experiments using glass cylinders demonstrated that the heating effect of the sun was greater in moist air than dry air. She detected the highest degree of heating occurred in a cylinder containing carbon dioxide.
1859 John Tyndall prove the greenhouse effect: “Such changes may in fact have produced all mutations of climate which researches of geologists reveal.”
1988 James Hansen, testified before the US Congress, and declared 99% confidence global warming was occurring leading to likelihood of extreme weather.

By foretelling of climate change scientists transformed observation into policy, The Paris Accord, ratified by 196 countries on 12 Dec. 2015. Excerpts:
Article 2 1. (a) Holding the increase in the global average temperature to well below 2° C. above pre-industrial levels and pursuing efforts to limit the temperature increase to 1.5° C. above pre-industrial levels, recognizing that this would significantly reduce the risks and impacts of climate change;
Article 4, 4. Developed country Parties should continue taking the lead by undertaking economywide absolute emission reduction targets. Developing country Parties should continue enhancing their mitigation efforts and are encouraged to move over time towards economy-wide emission reduction or limitation targets in the light of different national circumstances.

### Current Status of “the Climate Change Problem”

2022 Global energy-related CO2 emissions: 36.1±0.3 GtCO2T, a record high. Power accounted for 39.3% of the CO2 emissions total, industry 28.9%, ground transportation 17.9%, residential 9.9%, international bunkers (international aviation and shipping) 3.1%, and domestic aviation 0.9%. consistent patterns to previous years. Global atmospheric carbon dioxide: 417.06 ppm, a record high.
Total U.S. energy-related (CO2) emissions 4,964 million metric tons, (MMmt),
   31% Total was U.S. electric power sector (CO2) emissions 1,539 MMmt, 55% U.S. power sector CO2 emissions came from Coal 847 MMmt,
   43% U.S. power sector CO2 emissions came from Natural Gas 661 MMmt.
Total US Electricity Generation 4.24 Trillion kilowatt hours (KWH), split between:
   Natural Gas 39.8%, Coal 19.5%, Nuclear 18.2% and Renewables 21.5%
Atmospheric Temperature Status: a record high on, Monday 3 Jul. 2023.

### Inventive Step, Supportive Arguments

“Fulfilling a Need”: US fossil power generation 1539 MMmt & 2.51 Trillion KWH “Is that Need Now”: To achieve Article 2 means greenhouse gas emissions must peak before 2025 at the latest and decline 43% by 2030. Herein a known issue and the Accord does not provide a common structured mitigation path to achieve.

Professor Sir Bob Watson, former head of the UN climate body is currently Emeritus Professor of the UK's Tyndall Centre for Climate Research and one of the foremost climate scientists “World is struggling to prevent temperature rises as we are not reducing emissions fast enough. The big issue is we need to reduce greenhouse gases now to even be on the pathway to be close to 1.5 C or 2 C.” After 200 years, why is “The Climate Change Problem”, Not Resolved

There are many reasons both technical and non-technical which is well versed and not need to be repeated here: we are where we are. A line needs to be drawn on the past and what governments and organizations of today have inherited. Governments do need economically, politically, and socially acceptable technologies that can be replicated on a global basis, to replace the inventions of olde that produce anthropogenic emissions.

### Classification of “The Climate Change Problem”

United Nations Intergovernmental Panel on Climate Change provides reports based on climate models and authored by the global scientific community:
100% climate change is occurring now, classification is Known Issue
Time range for severity/temperature increase is “Uncertainty”
   Climate models are calibrated over time which will reduce the range of uncertainty.

### Risk Management Context:

Murphy's Law: “When it can go wrong, it will go wrong”. Identify what can go wrong and have a plan in place for if and when it does to minimize the impact to an acceptable level. Industry Managers recognize risk management and its preventative nature by having a system to minimize potential risks and addressing issues, uncertainties, and the unknown/unknowns.

Trying to solve climate change and planning for the unexpected, there are measures you can take once you can identify risks and correlate accrual of risk.

Major Accident Risk: A risk scenario with potential major implications that can have catastrophic impacts to people, economics, environmental, and reputation. Known to be hard to identify as the scenario may be a result of multiple risk events occurring simultaneously with the impact collective.

Explained by those Skilled in the Art using a “Swiss Cheese” visual for the layperson: an unexpected alignment of “holes” results in an event with unforeseen disastrous consequences, typically: Low Probability, High Consequence. By identifying the worst case scenario this enables decision makers make informed decisions in time for reform to yield tangible results, not after the fact. Notwithstanding increased probability of the risk event to occur without said reform.

Risk Matrix: Visual for assessing potential impacts, pre and post mitigation

Probability: Assessed likelihood of a potential pre-defined risk scenario to occur:

Impact: Consequences/Severity Range if a pre-defined risk scenario occurred

Risk Breakdown Structure: Important for screening the project and identifying potential combinations of risk events

Risk Accountability: clear line of sight through complex organization to determine responsibility from a legal perspective: i.e., negligence if risk occurs.

Risk Management System: a procedure. The context herein, initiates an Ecosystem Risk Management System, which can be ratified by Accord Parties. Pre-Mitigation=prior to risk event, to prevent or reduce probability of occurrence Post-Mitigation=post risk event, to minimize severity of outcome

### Assessment of the Solution to “the Climate Change Problem”, What can go Wrong?

ACCORD Objective “Hold the increase in the global average temperature to well below 2° C. above pre-industrial levels and pursuing efforts of 1.5° C. above pre-industrial level”.
Anthropogenic Emissions: Busy as Usual, mitigations planned for long term,
Anthropogenic Emissions: Forecasting Ecosystem tipping points, feedback loops,
Anthropogenic Emissions: Errors in reporting statistics or fraud i.e., “Dieselgate”,
Anthropogenic Emissions: Collapse of Atlantic Meridional Overturning Circulation,
Anthropogenic Emissions: Warming Carbon Sinks, and unknown/unknowns,
Anthropogenic Emissions: Ocean phytoplankton produce almost two-thirds of the planet's total atmospheric oxygen, collapse photosynthesis due oceanic warming,
Anthropogenic Emissions: Extreme weather impacts to renewable energy sources,
Economic: Alternative technologies products not competitive in energy markets,
Organizational: Planning & resources to collectively implement global mitigations,
Organizational: Scientific understanding for accrual of major risk scenarios,
Reputational: Alternative technologies not acceptable to NGOs and or population,
Reputational: Alternative technologies not acceptable due to loss of employment,
Political: Immediate crises take precedent, i.e., escalation of war in Ukraine,
Political: to protect Nation's comparative economic advantage Accord withdrawal,
Political: Lobbying sustain industry practice: no market reforms or taxation of CO2,
Political: Alternative energy technologies deemed threat to security of supply,
Political: Inability to take transformative action on Anthropogenic Emissions is overtaken by sequential extreme weather events resulting in loss of governance.

### Risk Event

Potential for exponential rise in Earth's Atmospheric Temperature, due to unabated anthropogenic emissions triggering multiple ecosystem tipping points.

### Risk Event Visual

The risk visual, shown in FIG. 11 provides an aid for audit of present green technology solutions or market mechanisms, wherein decision makers need to ask are they primary barriers, secondary barriers or in fact contributing to the cause. The important questions are we being a prudent operator or in hindsight negligent?

Not being aware should not be chastised but resolved in hindsight.
Legend: Anthropogenic Emissions (A.E.), Atmosphere (A.), Biosphere (B.), Cryosphere (C.), Hydrosphere (H), Tipping Points (T.P.) Primary Barrier (P.B.) Secondary Barrier (S.B) Risk Event (R.E.)
Probability: Exceptionally unlikely 0-1% or very unlikely 0-10%

Near term (to 2030), increasing medium term (up to 2050) and long term (to 2100)
Consequence (C.1): Atmospheric Temperature exceeds Livable Limits,
Consequence (C.2.): Atmospheric Oxygen subceeds Livable Limits,
Consequence (C.3): A Mass Extinction Event, Human Species
Consequence (C.4): Extreme Weather Events/Droughts, Poverty & Displacement,
Consequence (C.5): Wildfires, Warming Rising Ocean, Fisheries, Crops/Livestock.
5 Recommended for quantitative calibration, facilitated by those Skilled in Art

Ecosystem Risk Mitigation Structure (RMS); Alternate Technology (ALT)

| No | Title | Description |
|---|---|---|
| 0 | Safety “Prohibition” | Loss of Revenue/Use by Outmoded Fossil Fueled Assets |
| 1 | Execution | Physical Implementation of alternative technologies |
| 2 | Operation | Security of Supply from alternative technologies |
| 3 | Market Failures | Alternative Technologies (ALT) are not commercially viable |
| 4 | Climate Models | Accuracy (ACC) of reporting, statistics & model calibration |
| 5 | Climate Models | ACC of Tipping Points, Feedback Loops, CO2 Sink release |
| 6 | Climate Models | ACC of Compound events leading to Exponential Increase |
| 7 | Climate Models | ACC Oceanic Temperature for Photosynthesis Collapse |
| 8 | Social Messaging | Layperson: Neutral “Voice” as we all “own the risk” |
| 9 | Governance | Audit trail for a Prudent Operator: Prove not Negligent |
| 10 | Energy Supply | ALT electricity generation, energy production activities |
| 11 | Business | ALT fuel combustion, energy use in industrial sectors |
| 12 | Transport | ALT road transport, domestic aviation & shipping, railways |
| 13 | Transport | ALT International aviation and International shipping |
| 14 | Public | ALT combustion of fuel in public sector buildings |
| 15 | Residential | ALT fuel combustion in heating/cooking, garden machinery |
| 16 | Agriculture | ALT livestock, agricultural soils and agricultural machinery |
| 17 | Industrial processes | ALT resulting from industrial processes |
| 18 | Land use, forestry | ALT cropland, grassland, wetlands, and harvested wood |
| 19 | Waste management | ALT solid/liquid waste, landfill, incineration, composting |
| 20 | Military & Space | ALT fuel combustion, energy use in military/space sectors |

### Accountability for Delivery of Risk Mitigations

Accountability for systematic delivery of solutions could be placed with a neutral third party organization, but who could hold such a mantle. A better degree of success is to replicate systems by nations: Recommended RMS be replicated per signatories to Paris Accord, with government accountability for each category. Note. RMS categories 10/19 replicate IPPC reporting, subcategories to be added.

### Risk Mitigation Classification: Primary, Secondary or Neither

Many inventions or market mechanisms claim to be associated with a solution to said Climate Change Problem, however by representing this as a major accident risk event this enables solutions to be identified as either primary barriers to mitigate or secondary mitigation barriers to monitor, or neither, i.e., Carbon Trading Mechanisms or Harvesting of wood products for generation do not prevent occurrence of Risk Event, in fact they contribute to the cause of it. Rationale: Emissions are released into a closed atmospheric system, with carbon sinks planted to offset. “Time” an important factor with achieving Accord Objectives and prior to occurrence of said risk event. “Time” to Offset needs to be factored in.

### Category 10 of Risk Mitigation Structure: Electricity Generation

The State of the Art and the invention herein are Category 10 mitigations. Field of the Invention: The State of the Art invention relates to electric power generation and, in particular, floating offshore electric power generation utilizing artificial carbon dioxide capture and sequestration in the ocean.

### State of the Art: Detailed Description of Preferred Embodiments

The present invention, in part, utilizes the part that the OCC plays in the overall carbon cycle. It is generally recognized that the ocean is a carbon sink since it takes up more carbon from the atmosphere than it gives out. Thus, carbon dioxide from the atmosphere dissolves in the waters of the ocean. While some of the carbon dioxide stays as dissolved gas, some is converted into other things. For example, photosynthesis by tiny marine plants (phytoplankton) in the sunlit surface water turn the carbon into organic matter. Further, many organisms use carbon to make calcium carbonate, the building material of shells and skeletons.

Other chemical processes also create calcium carbonate in the water. The using up of carbon by biological and chemical processes allows more carbon dioxide to enter the water from the atmosphere. In short, carbon, e.g., from CO2, incorporates itself into marine organisms as organic matter or as calcium carbonate.

There are predictions based on mathematical modelling that disposal of CO2 into the surface ocean (<1 km depth) would permit equilibration with the atmosphere within a few years to decades and would therefore offer little advantage, but that disposal into ocean basins greater than 3 km in depth would delay equilibration with the atmosphere for several hundred years, eliminating the atmospheric concentration transient. Resultant interaction with calcite-rich sediments may reduce the long-term (>2000 year) atmospheric enrichment by a significant amount (−50%). In any event, many of the interactive processes between marine organisms and CO2 could result in the locking up of carbon for millions of years. Further, CO2 sequestration may be more efficient in colder oceanic waters since it is known that the solubility of carbon dioxide in water increases with decreasing temperature.

Referring first to FIG. 1, there is shown a floating structure 10, which can be a barge, platform, or the like, and which can be dynamically or statically positioned at a suitable offshore location. The positioning of structure 10 in deep water can be accomplished using well known methods used in deep water positioning and mooring of drilling and production platforms in the oil and gas industry. Mounted on structure 10 is a gas processing I optimization module 12 which is connected by a conduit 14 to a pipeline 16 laying on the seabed 18. Generally speaking, gas pipeline 16 will be for the transport of light hydrocarbon gases, e. g., natural gas which contains primarily methane. In gas processing module 12, gas transferred from pipeline 16 and line 14 can be treated in various ways well known to those skilled in the art to remove unwanted contaminants, water, and other components that would deleteriously effect downstream operations. Module 12 can also include separation and enrichment systems to optimize BTU content of the gas from pipeline 16.

Also mounted on structure 10 is a power station module shown generally as 20 and which can comprise a driver, e.g., a gas turbine, or steam turbine, both of which are well known to those skilled in the art and both of which, in the present invention, would be powered directly or indirectly from the combustion of a fuel, e.g., processed natural gas transferred via line 24 from processing module 12. The combusted gas (flue gas) generated in the driver or power section 22 of module 20 is sent to a gas collection system comprised of a compression station 26 to compress the flue gas and transfer it to a conduit or line 28 to a subsea location at a desired optimal depth which can be in the sunlit waters of the ocean, but is preferably, for reasons discussed above, in a deeper ocean pool at about 3 km or greater below the ocean surface. In a preferred embodiment, prior to compression in compression station 26, the flue gas is sent to a carbon dioxide separation station 25 wherein the carbon dioxide is separated from the flue gas by absorption, adsorption, membrane gas separation, or other methods well known to those skilled in the art. The carbon dioxide only is then sent to compression station 26 and ultimately transferred to a subsea location by conduit 28. The non-carbon dioxide components of the flue gas are then processed and disposed with by means well known to those skilled in the art.

The turbine comprising driver 22 is mechanically connected in a well-known fashion to an electric power generator 24 whereby electric power is generated and transferred via line 28 to an electric power substation 30. Substation 30 will generally have switching, protection, and control equipment, and transformers, the output from substation 30 being transmitted via electric power transmission line 32 to a remote location, preferably on land where it can be distributed as needed.

Turning now to FIG. 2, there is shown another embodiment of the present invention. The embodiment shown in FIG. 2 is substantially the same as that shown in FIG. 1 with the exception that gas from pipeline 16 is transferred via line 14 to a gas storage tank 15 positioned on structure 10. The gas in storage tank 15 is transferred via line 13 to gas processing module 12. In all other respects, the embodiment of FIG. 2 is the same and functions in the same manner as the embodiment of FIG. 1.

Turning now to FIG. 3, there is shown another embodiment of the present invention which is similar to the embodiments shown in FIGS. 1 and 2, with the exception it employs liquified natural gas (LNG) as a fuel source. To this end, there is a barge or ship 42 which has a compartment or vessel 44 carrying LNG, the LNG being transferred form compartment 44 via line 48 to storage vessels 46 on structure 10. LNG is transferred via line 47 to a regasification module 50 and thereafter regasified liquid natural gas (RLNG) via line 52 to gas processing module 12. Using fuel injection technology, it may be possible for LNG to be used as a fuel, without regasification. In all other respects the embodiment of FIG. 3 is the same and functions in the same manner as the embodiment of FIGS. 1 and 2.

Referring now to FIG. 4, there is shown a schematic layout of a typical gas turbine system that can be used in the power generating system and method of the present invention. The gas turbine system of FIG. 4 comprises a compressor coupled by shaft 62 to a turbine 64. In a well-known manner, air is introduced into compressor 60 via line 66, the air being compressed and then transferred via line 68 to a combustion chamber 70 where it is admixed with a suitable fuel, e.g., natural gas, LNG, the fuel igniting in combustion chamber 70 to generate a high temperature, high pressure gas flow which is introduced via line 74 into turbine 64 to drive turbine 64 wherein it expands down to an exhaust pressure producing a shaft work output via shaft 76 which can then drive an electric power generator, e.g., generator 24. The carbon dioxide combustion gas from turbine 64 is then captured for transfer via line 28 for sequestration at a suitable depth below the surface of ocean as described above with respect to embodiments of FIGS. 1-3.

In the case of a steam turbine, the natural gas would be used to convert water to steam, the steam in turn being used to spin the turbine, the output shaft of the turbine being coupled to an electric generator as in the case of the gas turbine. It is further contemplated there could be combination of gas and steam turbines, similar to configurations on land based combined cycle power stations which are well known to those skilled in the art.

In all of the embodiments discussed above, either natural gas or LNG has been used as a fuel source. However, it is within the scope of the present invention for the fuel source to comprise oil, heating oil and other hydrocarbon liquids. Further, the fuel source could comprise coal which could be transferred by barge from the shore to the offshore structure, the coal forming fuel for a boiler generating steam to drive a steam turbine. While admittedly the use of coal poses greater combustion gas capture problems, there are known technologies for capturing combustion gases from the burning of coal or similar solid fossil fuels, which can trap noxious gases other than CO2 and transfer the remaining CO2 into the ocean as discussed above with respect to the embodiments shown in FIGS. 1-3. Such a system might be useful where conditions make it difficult to supply the system with natural gas, LNG, or other similar fluid fossil fuels, and wherein the adjacent land is rich in coal deposits. Further, waste paper products could also be used as a fuel source.

It is further contemplated that the carbon dioxide collection system may include systems for adding chemical additives, if required, prior to subsea transfer to mitigate potential for localized ocean acidification, due to point source oceanic sequestration of carbon dioxide.

As described above, the structure can be a floating structure similar to deepwater oil and gas offshore platforms, or a fixed structure similar to current, relatively shallow water oil and gas platforms, thereby forming a semi-permanent structure. However, the use of some type of floating structure is preferable since it allows the system to be transferred at will from one location to another to optimize cost considerations.

It will also be understood that feed stock and electric power or export connections will be of a type that could be quickly disconnected to allow the structure to be moved in the event of weather related events such as hurricanes.

It will be further understood that the power plant, depending upon what type of turbine(s) are employed can also comprise boilers, steam generators, pumps, and typical equipment used in onshore electric power generating stations and systems as well known to those skilled in the art.

It is further contemplated that the system could also include a separate vessel or structure having electric power storage capabilities.

State of the Art: End

### State of the Art, Technical Limitations

Implies proximity to a location of deepwater and a remote oceanic location wherein to supply base load electricity for onshore regional load centers will incur transmission losses. Economics is not addressed by patentability; however, it is implied that by improving the operational performance of a system and therefore improving the overall system efficiency you are by default improving economics.

### Competitive Wholesale Markets

Centralized wholesale markets where generators sell power and load-serving entities purchase it and sell it to consumers provide an economically efficient method of Wholesale Deregulation. In the US, following deregulation, regional transmission organizations (RTOs) replaced utilities as grid operators and became the operators of wholesale markets for electricity.

Dispatching units by lowest cost allows the market to meet energy demand at the lowest possible price. During periods of high demand, wholesale prices rise accordingly, because more high-cost units need to be dispatched to meet load.

### RTO Transmission Constraints

Base wholesale market prices typically reflect the price for power when it can flow freely without transmission constraints across the RTO's territory. When that is not possible, RTOs account for congestion on transmission lines by allowing prices to differ by location: areas with high demand and scarce electric resources typically have higher prices than those with abundant generation relative to load. Transmission System; Fixed Losses and Variable Losses.

Known to those Skilled in the Art: fixed losses occur within the iron cores of transformers, cables, and overhead lines whenever the circuit is energized. The magnitude of these losses is not dependent on the magnitude of the current being carried by the conductor but rather the magnetic field created by the applied voltage and the induced currents this creates within the iron core. As the voltage is more or less constant, these losses are also considered non-varying Known to those Skilled in the Art: variable Losses are the “classic” losses which vary with the current carried by the conductor. These losses occur in cables, overhead lines and transformers and are dependent on the degree of resistive heating experienced. Losses in transmission systems are a function of the current carried by the conductor and the resistance of said conductor. This resistance causes energy to be absorbed by the conductor which results in the conductor heating up in the same way as an electric bar heater. This energy is lost to the surroundings. The resistance of an individual conductor is in turn a function of the materials used in its construction, how these are combined, and the length of the conductor. Multiple transmission system components can be considered as a single route with its own characteristics.

In this way, the route that energy fed in to the north of Scotland takes to reach the demand centers in the south of England can be thought of as a very long conductor. As a longer length increases the overall resistance, and hence transmission losses, you can see that the location of generation infeed relative to demand will affect the level of transmission losses experienced.

### Technical Solution for State of the Art Limitations

Typically, large scale base load power generation systems are located near the source of fuel or in the case of the State of the Art, close proximity to a remote deepwater location for carbon dioxide sequestration.

Replacing the current approach for oceanic carbon dioxide sequestration with an onboard carbon dioxide upgrading system enables the combined invention to negate RTO transmission constraints with a new location for the State of the Art Power Generation System: offshore high demand coastal centers, i.e., New York.

### Electrolysis

In 1830's Michael Faraday published his two laws of electrolysis, provided a mathematical explanation for them. Coincidental, timing with the discovery of Climate Change, therein appropriate this to be part of the solution.

Electrolysis is process for interchange of atoms and ions by the removal or addition of electrons due to the applied current, in a unit called an electrolyzer. Electrolyzer functionality depends on type of electrolyte material involved, and the ionic species it conducts with three main types of electrolysis: alkaline electrolysis, polymer electrolyte membrane electrolysis and solid oxide electrolysis cell.

CO2 Electrolysis: DC electricity to split CO2 into carbon monoxide (CO) & oxygen to produce value-added chemicals such as methane, ethylene, ethanol.

H2O Electrolysis: DC electricity to split water into hydrogen (H2) & oxygen.

Co-Electrolysis of CO2 & H20: CO2 is converted to CO and H20 to H2.

### Nomenclature: For Teaching Purposes

Seawater Filtering Plant, i.e., desalination to separate salt, other impurities. Fuel Cell: Stored hydrogen in cell mixed with air oxygen, to produce DC Power. Power Cell: Stored electricity in cell, to produce DC Power.

Heat Recovery Steam Generator: Heat of the gas turbine's exhaust can be high as 450 to 650° C. (723K to 923K) which is used to generate steam by passing it through a heat recovery steam generator with a live steam temperature. The steam condensing and water system is the same as in the steam power plant. Auxiliary Firing: Typical gas turbine exhaust contains 13-15% oxygen by volume which is adequate to fire additional fuel, to raise exhaust gas temperature.

Intermediate Temperature Steam Electrolyzer: Proton-conducting ceramic electrolytes use a lower operating temperature to function operationally. The operation of the electrolyzer is typically in temperature range of 600° C. to 650° C.

Fischer-Tropsch: A chemical process developed in the 1920s to convert a mixture of carbon monoxide and hydrogen, called synthesis gas or syngas, into hydrocarbon chains of varying lengths, which can used as synthetic fuel.

Solid Oxide Electrolyzer: use a solid ceramic material as the electrolyte. They must operate at temperatures high enough for the solid oxide membranes to function properly (typically 700°−800° C.) i.e., effectively use high temperatures to decrease the amount of electrical energy needed to produce hydrogen from water.

Solid Acid Electrolysis Cell: CO2 feedstock, steam, and cell operation at temperatures in the range 150-250 C produces carbon monoxide, methane, methanol, ethane, ethylene, ethanol, acetaldehyde and propylene.

### Inventive Step Substantive Examination

It is taught that consideration is needed when an invention may be to a combination or a collocation. The first step is to decide whether you are dealing with one invention or, two or more inventions. If two integers interact upon each other, if there is synergy between them, they constitute a single invention having a combined effect as portrayed by using The State of the ART as an example:

Invention/Integer 1.

[Thermal] Electric Power Generation System, comprising
Floating Offshore Structure or fixed Semi-permanent Structure
Fuel source options: GAS, LNG, Coal, Oil, Heating Oil, other Hydrocarbon Liquids & Wastepaper Products
Gas Storage Tank, Gas Processing Module & Gas Optimization Module or LNG Storage Tank, Regasification Module, GAS Processing Module & GAS Optimization Module or
LNG Storage Tank, GAS Processing Module and GAS Optimization Module
Power Generation Module—typical equipment used in onshore electric power generating stations
Substation with switching, protection, control equipment, and transformers
Subsea Power Cable
Vessel or structure having electric power storage capabilities
Turret disconnect for Fuel and Subsea Power Export

Invention/Integer 2.
Carbon Dioxide Sequestration using the Oceanic Carbon Cycle, comprising
Carbon Dioxide capture and separation station,
Systems for adding chemical additives
Compression station to compress the gas and transfer it to a
Conduit to a subsea location 3 km or greater below the ocean surface

Integer 1 and Integer 2 are interrelated but independent, however when combined they provide the solution of delivering base load power generation from a carbon neutral electric power generation facility, employing fossil fuels.

### Solution Invention/Integer 3.

Carbon dioxide upgrading system, comprising
Carbon dioxide capture and separation station,
Seawater filtration system,
AC/DC convertor system,
Sequestration system with a Heat Recovery Steam Generator, an Intermediate Temperature Steam Electrolyzer and H2 & CO Storage System,
Production System incorporating a Fischer-Tropsch Synthesis process,
Product Upgrading system,
Storage and offloading system,
Steam Regeneration system connected to a Steam Turbine and Generator.

Integer 1 & Integer 3 are interrelated but independent, however when combined they provide the solution to Transmission Losses from remote base load power station by removing the requirement for proximity to deep water, and relocation to proximity of high demand coastal load centers. The said carbon dioxide upgrading system is a value add, instead of value negative (cost). The system recycles the byproduct cardon dioxide to produce syngas which is supplied to the Fischer-Tropsch Synthesis Module with synthetic crude transferred to the Product Upgrading Module to produce liquid and gas fuel products. Fulfilling a need, as the UN IPPC teaches with hydrogen and CO2 as feedstocks to produce gasoline or methanol, this alleviates converting the transport sector to hydrogen.

### Inventive Step, Collocations

It is further taught that two features interact synergistically if their functions are interrelated and lead to an additional effect that goes beyond the sum of the effects of each feature taken in isolation. It is not enough that the features solve the same technical problem or that their effects are of the same kind and add up to an increased but otherwise unchanged effect.

Combination of Integer 1 & Integer 3 can be compared to a transmitter and receiver which work only together and characterized in additional independent claims. As a prudent operator in a carbon constrained world, the use of fossil fuels for power generation (Integer 1) requires a sequestration system (Integer 3) and they work only together. Further to being aware of the potential risk event, to continue fossil fueled power generation, without sequestration, is simply negligent.

### Inventive Step, Obvious

Would this inventive concept been obvious to someone skilled in the art tasked with solving said “Problem” of transmission losses from remote base load power generation stations, at the time of filing this application.

Why would someone Skilled in the Art select a floating offshore, base load, power generation solution as it is common industry knowledge to be a cost prohibitive exercise to locate a large-scale thermal power station, at an offshore location, notwithstanding the challenges of carbon sequestration to achieve carbon neutrality. Criteria at the time of filing would dictate onshore gas fired, power generation and incur said transmission losses to enable competitive dispatch.

### Inventive Step, Fulfilling a Need,

The fact is there was no real explanation why this combined inventive concept was not taken up well before now. The simplest explanation, indeed, the only one that fits the known facts is the inventors hit upon something which others had missed when working on mitigation solution to potential climate change risk.

### What is the Inventive Step/Solution?

So, my inventive step may be the way of solving the problem and my inventive step is that solution:
Problem: transmission losses from remote base load power generation stations
Solution: Floating Offshore Carbon Neutral Electric Power Generation System & Carbon Dioxide Upgrading System, utilizing Seawater

### SUMMARY OF THE INVENTION

The present invention application acknowledges further independent claims are only justified where the inventive concept covers more than one category, e.g., apparatus, use, process, product, and complementary versions within one category, e.g., plug and socket, transmitter, and receiver, which work only together.

The system and method of the present invention contains complementary versions, and with reference to said plug and socket example, they only work together to complete carbon neutrality.
An apparatus as defined in claim 1 and claim 2.
A method as defined in claim 13 and claim 14
A product as defined in claim 25
A use of said product as defined in claim 26

These and further features and advantages of the present invention will become apparent from the following detailed description, wherein reference is made to the figures in the accompanying drawings.

### BRIEF DESCRIPTION OF THE DRAWINGS

FIG. 1 for reference: a simplified schematic view of one embodiment of the electric power generating system of “The State of the Art” invention.

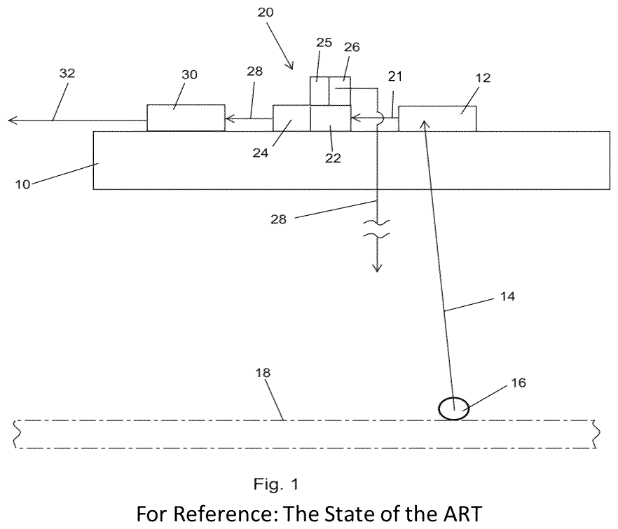

FIG. 2 for reference: is a view similar to FIG. 1 showing another embodiment of the “The State of the Art” invention.

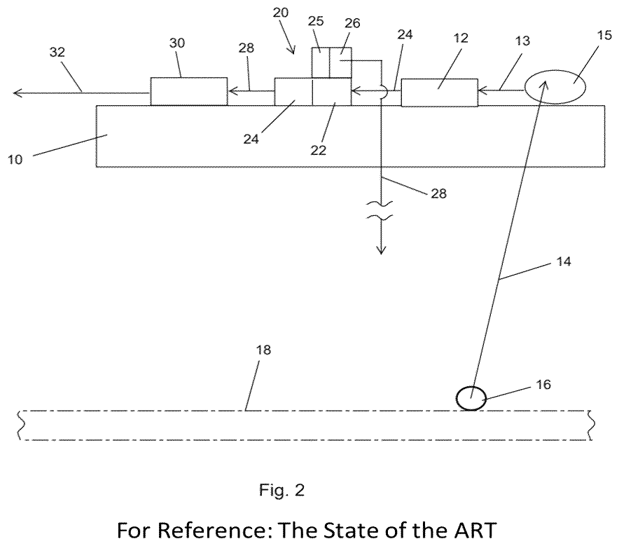

FIG. 3 for reference: is a view similar to FIG. 1 showing another embodiment of the “The State of the Art” invention.

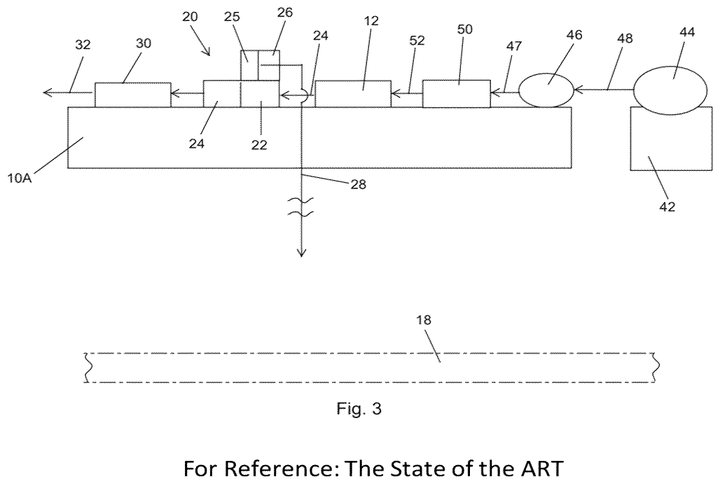

FIG. 4 for reference is a simplified schematic view of a typical gas turbine system that can be employed in the system and method of The State of the Art invention.

FIG. 5 is a simplified schematic view of steam sequestration system that can be employed in the system and method of the present invention.

FIG. 6 is a view similar to FIG. 5 showing another embodiment of the present invention.

FIG. 7 is a view similar to FIG. 6 showing another embodiment of the present invention.

FIG. 8 is a view similar to FIG. 7 showing another embodiment of the present invention.

FIG. 9 is a view similar to FIG. 8 showing cumulative embodiment of the present invention that can be employed in the system and method for said invention.

FIG. 10 is a simplified schematic view of cumulative embodiments of the invention integrated with base load generation system of the State of the Art that can be employed in the system and method of the combined invention.

FIG. 11 is a visual aid of risk events.

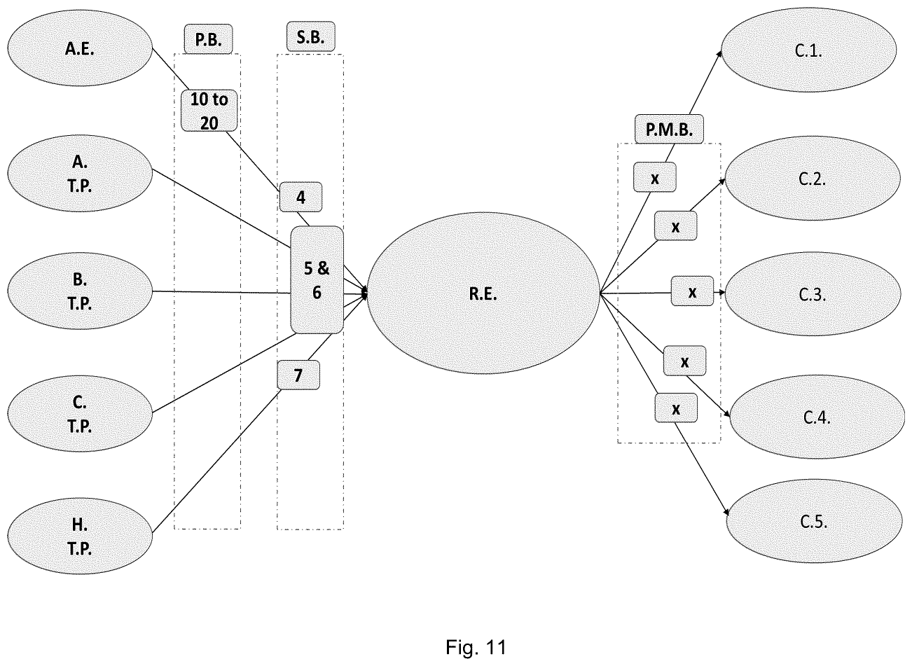

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

The present invention improves operational efficiency of the power generation system of “The State of the Art”, with onboard sequestration of the byproduct CO2, enabling the floating structure 10B to be located in proximity to coastal cities with high demand, negating transmission losses. The new combination is in essence: Floating Offshore Carbon Neutral Electric Power Generation System & Carbon Dioxide Upgrading System, utilizing Seawater

Onboard sequestration system utilizes in part the carbon cycle, by recycling the byproduct carbon dioxide into feedstock for syngas, an alternative to hydrocarbon feedstocks used in the production of present syngas. An onboard Fischer-Tropsch Synthesis Module and Product Upgrading Module produces liquid and gas fuel products utilizing processes well known to those skilled in the art. This enables additional energy products for transportation sector with proximity to high population centers and high demand. This implies a commercial uplift for said energy products and subsequent economic operation for “The State of the Art”.

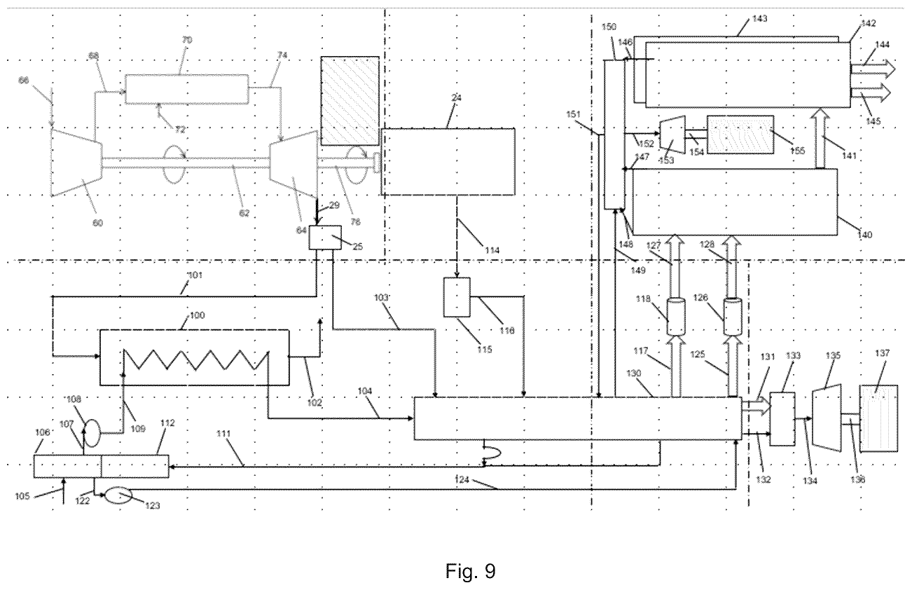

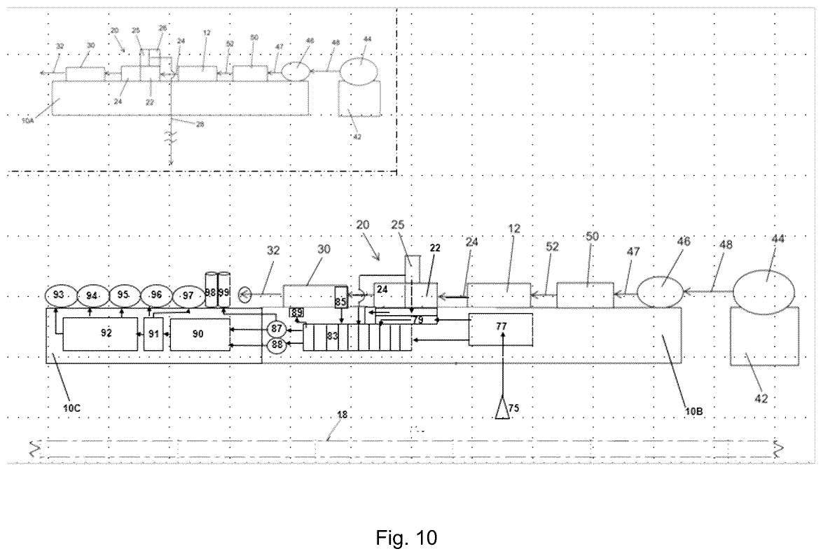

There are five embodiments described for the present invention, each with a schematic drawing. For clarity, each embodiment and drawing is a sequential buildup for the carbon dioxide upgrading system, from carbon dioxide gas to producing liquid and gas fuel products. The overall system schematic is in FIG. 9., with integration on the offshore structure 10B and said State of the Art, FIG. 10.

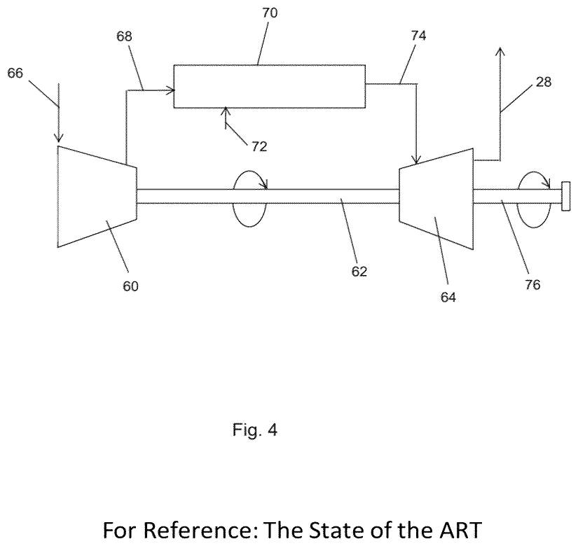

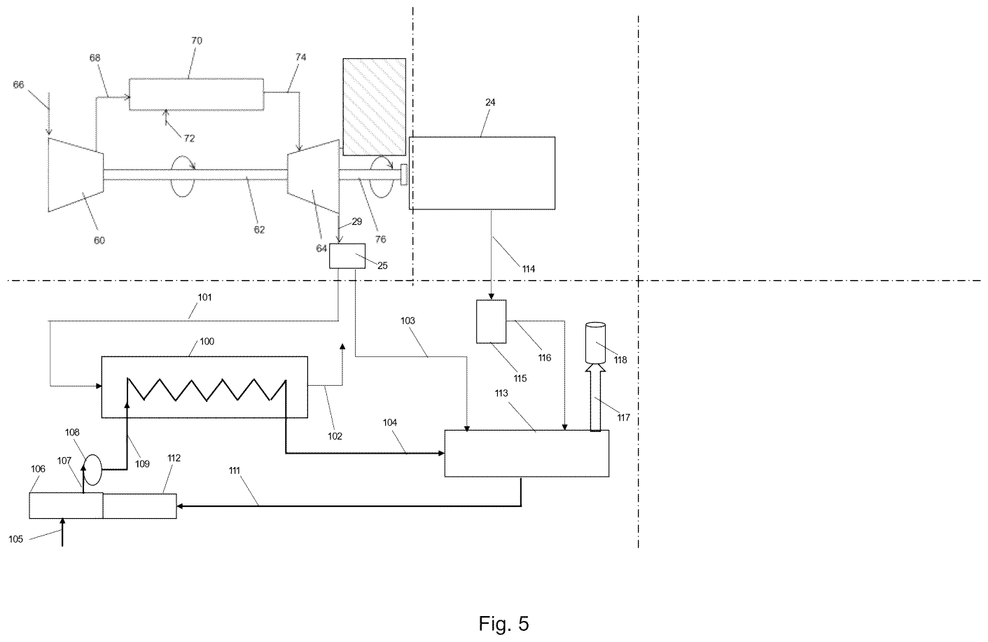

The first embodiment is an onboard carbon dioxide sequestration system with the corresponding schematic in FIG. 5. To confirm what is new in the present invention and tie-in points, gas turbine schematic of “The State of the Art”, FIG. 4, is shown in the top left corner. The hatched area overlays prior system CO2 tie-in.

Foundation of said sequestration system is the technical integration of a Heat Recovery Steam Generator (HRSG) and an Intermediate Temperature Steam Electrolyzer (ITSE) enabling continuous electrolysis of carbon dioxide gas into a feedstock of carbon monoxide gas. The process requires DC power supply.

The system of the present invention begins with a Seawater Filtration Plant (SFP) 106 similar to desalination system, to remove containments from seawater that could impact the operation of the HRSG 100 and ITSE 113 respectively. The SFP has a pumping system which draws seawater from the water column via line 105. Output from the SFP is water via line 107 to the HRSG Pump 108. The HRSG Pump 108 supplies water, via line 109, an input to the HRSG 100.

Output from the HRSG is Intermediate Temperature Steam which is transferred via line 104 to the ITSE 113. Further to the electrolysis process, steam is recycled via line 111, to condenser 112 and then back to the SFP for purification.

The Gas Turbine 64 is operated in Cogeneration mode with the flue gas sent, via line 29, to a carbon dioxide separation station 25 wherein the carbon dioxide is separated from the flue gas by absorption, adsorption, membrane gas separation, or other methods well known to those skilled in the art. The carbon dioxide is then sent, via line to 103 to the CO2 ITSE 113. The non-carbon dioxide gas flue gases are sent via line 101, to the input of HRSG 100. Said HRSG has auxiliary firing capabilities from Hydrogen Gas, (product of 2nd Embodiment). Said non-carbon dioxide flue gases exit the HRSG, via line 102, to be processed and disposed with by means well known to those skilled in the art.

DC Power to CO2 ITSE 113, is via line 118 from AC/DC Convertor 115, which has a battery backup to account for potential supply interruptions. Convertor 115 is supplied with AC power via line 114 from State of the Art Generator 24.

CO2 Electrolyzer 113 utilizes Intermediate Temperature Steam Electrolysis (ITSE) to split carbon dioxide, by process well known to those skilled in the art.

CO2 Electrolyzer 113 Output is carbon monoxide gas (CO), sent via line 117 to the CO feedstock storage system 118.

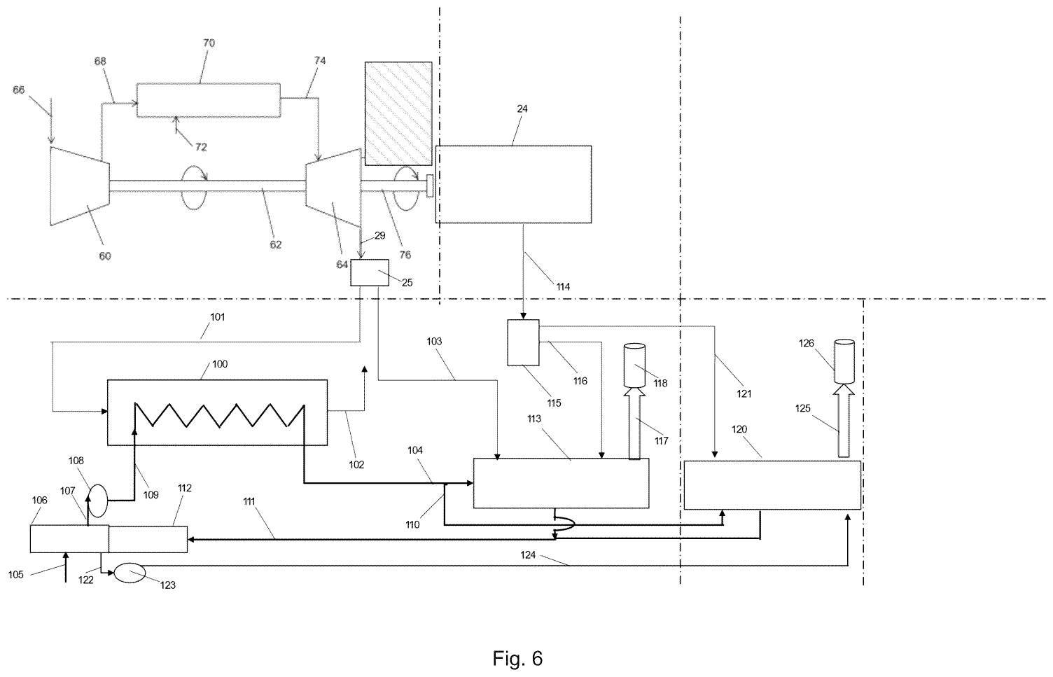

The second embodiment is the addition of a H20 electrolysis system to produce Hydrogen gas (H2) with the schematic in FIG. 6

H20 Electrolyzer 120 utilizes Intermediate Temperature Steam Electrolysis (ITSE) to split H20 water, by a process well known to those skilled in the art.

DC Power to H2O ITSE 120, is via line 121 from the AC/DC convertor 115

H20 is supplied by the SFP 106 via line 122 to pump 123 and line 124 input to the H2O ITSE 120

Intermediate Temperature Steam is supplied via line 110, which is connected to line 104 which supplies CO2 ITSE 113. Post-electrolysis, steam is recycled via line 111, to condenser 112 and then back to the SFP for purification.

H20 Electrolyzer 120 Output is hydrogen gas (H2) sent via line 125 to the H2 feedstock storage system 126.

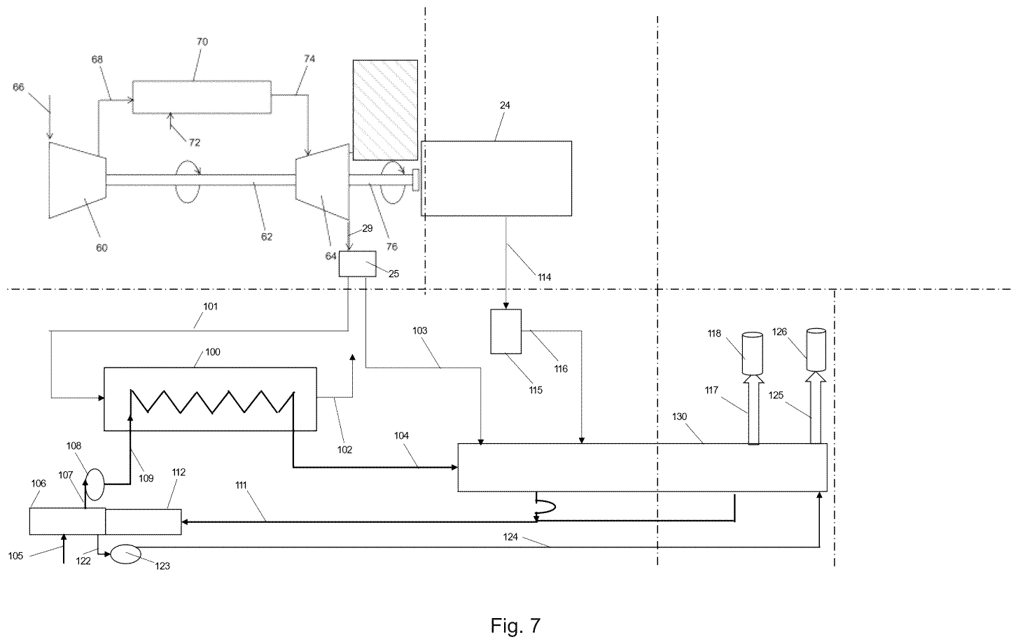

The third embodiment is a co-electrolysis system with the corresponding schematic in FIG. 7. Input and Outputs are similar to FIG. 5 and FIG. 6 embodiments.

Electrolyzer 130 uses Intermediate Temperature Steam Electrolysis (ITSE) to split both CO2 and H20, by a process well known to those skilled in the art.

DC Power to ITSE 130, is via line 118 from AC/DC convertor 115 H20 is supplied by the SFP 106 via line 122 to pump 123 and line 124 input

Carbon dioxide gas is transferred via line 103, to the ITSE 130. Intermediate Temperature Steam is supplied by HRSG via line 104, to ITSE 130. Carbon monoxide (CO) Output is via line 117 to CO feedstock storage system 118. Hydrogen (H2) Output is via line 125 to H2 feedstock storage system 126

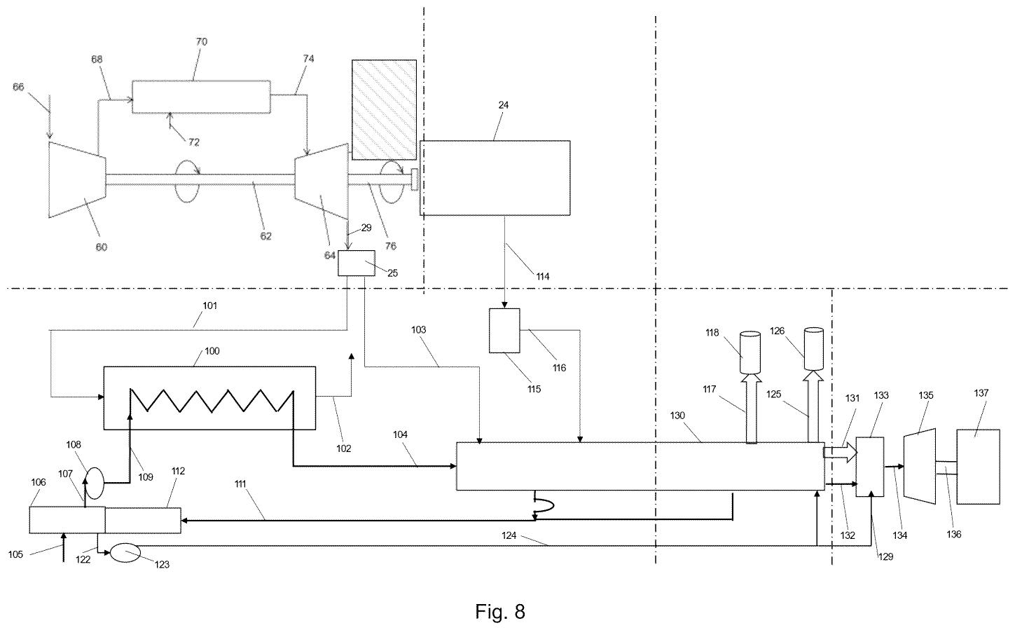

The forth embodiment is the addition of steam regeneration system to the third embodiment of Co-Electrolysis ITSE with corresponding schematic in FIG. 8.

A steam regeneration system 133 or alternative is supplied the post electrolysis steam for reuse, via line 132. Hydrogen gas is supplied via line 131 to the system 133 for reheating the steam by a process well known to those skilled in the art. Top up water is supplied, via line 129, from the SFP pump 123. System 133 supplies steam, via line 134 to spin the steam turbine 135, the output shaft of the turbine 136 being coupled to an electric generator 137

The fifth and final embodiment is the cumulative stage in recycle of carbon dioxide gas to alternative fuel products with the corresponding schematic in FIG. 9.

Addition of a The Production System is a Fischer-Tropsch Synthesis Module 140 and a Product Upgrading System with Gas Processing Module 142 and Liquids Processing Module 143.

The Fischer-Tropsch process was developed one hundred years ago and is now well known to those skilled in the art. The process converts a feedstock of carbon monoxide and hydrogen, synthesis gas or syngas which is sent at high temperatures through catalysts (usually the transition metals cobalt, iron, and ruthenium) which facilitate the hydrocarbon formation, into hydrocarbon chains of liquid hydrocarbons (C5-C25), to be used as synthetic fuel.

Input to the Fischer-Tropsch Synthesis Module 140 from the carbon monoxide storage system 118, via line 127. Another Input to the Fischer-Tropsch Synthesis Module 140 from the hydrogen storage system 126 via line 128.

Output from the Fischer-Tropsch Synthesis Module 140 process is a synthetic crude which is transferred, via line 141 to Product Upgrading System Modules, 142 and 143 respectively. Herein said synthetic crude is further processed supplying, aviation fuels, transportation fuels and feedstocks; i.e., Base Oils, Gas Oil, Kerosene, Paraffins, Naphtha or the gaseous products of Condensate, LPG and Ethane.

A storage and offloading system supplies appropriate vessels, or pipelines via lines 144 and line 145.

For operational efficiency, recycling process off gases via lines 146 and 147 and recycling of waste steam via line 148 into steam regeneration module 150 or alternative. CO2 from the Fischer-Tropsch process is recycled to ITSE via line 151. Redundant process oxygen from the ITSE 130 is supplied, via line 149 to module 150. Water to be supplied to module 150 via an extension of line 124 (not shown).

The regeneration module 150, supplies steam, via line 152 to steam turbine 153, the steam in turn being used to spin the turbine 153, the output shaft of the turbine 154 being coupled to an electric generator 155 to supply onboard loads.

It is contemplated to produce a hybrid fuel, combining hydrogen and diesel by processes defined in embodiments two and five, “HydroDiesel” (HD). For a viable product and to fulfill a need, said product characteristics are deemed as liquid fuel to supply diesel transportation, with no engine or exhaust modifications.

The sum of the embodiments, overlayed with the power generation system of the State of the Art is in FIG. 10. Embodiments one through four are shown in the hull of oceanic structure 10B, with Embodiment five show as an extension 10C in the shaded area. Said extension 10C may be separate vessel or structure.

Seawater is collected in the water column using an initial filter system 75 which is pumped to Seawater Filtration Module 77. This supplies water to the HRSG Module 89 and the ITSE Module 83.

The combusted gas (flue gas) generated in the driver or power section 22 of the State of the Art is sent to a carbon dioxide separation station 25 wherein the carbon dioxide is separated from the flue gas by absorption, adsorption, membrane gas separation, or other methods well known to those skilled in the art. The carbon dioxide only is then sent to the ITSE Module 83. The non-carbon dioxide gas is sent to the HRSG Module 79, where a heat exchange takes place, converting the feed water into Intermediate Temperature Steam which is supplied to the Intermediate Temperature Steam Electrolyzer 83.

Onboard Power Generation Module 24 supplies the AC/DC convertor Module 85 which in turn supplies DC power to the ITSE 83.

ITSE 83 produces syngas feedstocks which are stored in 87 and 88 for supply to the Fischer-Tropsch Module 90 and Product Upgrading Module 92. Produced liquids and gas are transferred from Module 92 to storage units 93 through 96 for offloading. Module 91 is steam a regeneration unit or alternative.

Fuel cells, hydrogen 98 or electric 99 are illustrated on deck for offloading.

It is further contemplated there could be combination of fuel cells fueled by Hydrogen, DC Power similar to transportation on land based vehicles, which are well known to those skilled in the art. Delivery of said fuel cells from the offshore structure may include drone delivery direct to residential homes or small business.

It is yet further contemplated there could be combination of gas and steam turbines fueled by hydrogen, similar to natural gas configurations on land based combined cycle power stations which are well known to those skilled in the art.

It is also further contemplated that the system could also include a separate vessel or structure having hydrogen storage capabilities and or hydrogen fuel cells.

A final contemplation, Substation 30 includes a ACDC converter station with DC power being transmitted via HVDC electric power transmission line 32 to a remote location. Where there are multiple offshore power generator systems operated by the same operator, they can be connected by an offshore DC super grid to regulate the supply to multiple coastal cities, working in partnership with RTO grid operators, governments, consumers to maximize benefit to all.

Although specific and cumulative embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations, and modifications, including but not limited to those design alternatives specifically discussed herein, may be made in the practice of the invention without departing from its scope.

What is claimed is:

1. A system for carbon dioxide upgrading, comprising:
an oceanic offshore structure;
an AC/DC convertor mounted on said oceanic offshore structure wherein said convertor is connected to the onboard electric power generating system; and
a seawater filtration system mounted on said ocean offshore structure, wherein includes separation and enrichment systems for filtered seawater; and
a sequestration system mounted on said ocean offshore structure, comprising a Heat Recovery Steam Generator, said Heat Recovery Steam Generator being connected to an Intermediate Temperature Steam Electrolyzer, wherein carbon dioxide combustion gases from said power generation system and said filtered seawater are processed to create feedstocks for syngas, and
a production system mounted on said ocean offshore structure, wherein said production system being connected to said sequestration system for transfer of said syngas to a Fischer-Tropsch Synthesis process for conversion to synthetic crude, and
a product upgrading system mounted on said ocean offshore structure, wherein said product upgrading system being connected to said production system for transfer of said synthetic crude to a product upgrading process for conversion to liquid and gaseous fuel products; and
a storage and offloading system, mounted on said ocean offshore structure for distribution of said products to a remote location.

2. A system for generating electric power system and carbon dioxide upgrading, comprising:
an oceanic offshore structure;
a gas processing and optimization module mounted on said ocean offshore structure, wherein said gas optimization module includes separation and enrichment systems; and
an electric power generating system mounted on said oceanic offshore structure, said electric power generating system including:
an electric power generator;
a driver powered by a combustion process of a fossil fuel source, said driver being connected to said generator;
an electric power transmission system to transfer electricity from said generator to a remote location; and
a capture system connected to said driver for capturing combustion gasses transferred from said combustion process, said capture system comprising:
a flue gas separation station for separating the carbon dioxide from non-carbon dioxide combustion gases by absorption, adsorption, or membrane gas separation, prior to transferring said carbon dioxide to an onboard sequestration system Intermediate Temperature Steam Electrolyzer with the non-carbon dioxide gas transferred to an onboard sequestration system Heat Recovery Steam Generator; and
an AC/DC convertor mounted on said oceanic offshore structure wherein said convertor is connected to said electric power generating system; and
a seawater filtration system mounted on said ocean offshore structure, wherein includes separation and enrichment systems for filtered seawater; and
a sequestration system mounted on said ocean offshore structure, comprising a Heat Recovery Steam Generator, said Heat Recovery Steam Generator being connected to an Intermediate Temperature Steam Electrolyzer, wherein carbon dioxide combustion gases from said power generation system and said filtered seawater are processed to create feedstocks for syngas, and
a production system mounted on said ocean offshore structure, wherein said production system being connected to said sequestration system for transfer of said syngas to a Fischer-Tropsch Synthesis process for conversion to synthetic crude, and
a product upgrading system mounted on said ocean offshore structure, wherein said product upgrading system being connected to said production system for transfer of said synthetic crude to a product upgrading process for conversion to liquid and gaseous fuel products; and
a storage and offloading system, mounted on said ocean offshore structure for distribution of said products to a remote location.

3. The system of claim 2, wherein said oceanic offshore structure is fixed or floating.

4. The system of claim 2, wherein said fossil fuel source is supplied to said gas processing and optimization module on said oceanic offshore structure by a line connected to either:
a conduit connected to a seabed pipeline; or
a gas storage tank connected by a conduit to a seabed pipeline; or
storage vessels connected by a line to a barge or ship.

5. The system of claim 2, wherein said driver is gas combustion turbines, or combination of gas and steam turbines, or LNG turbines with fuel injection, or combination of LNG turbines with fuel injection and steam turbines.

6. The system of claim 2, wherein said oceanic offshore structure can disconnect fuel and transmission system connections for transit to a different location.

7. The system of claim 2, wherein said power generating system provides base load power generation to said remote location.

8. The system of claim 2, wherein said power generating system comprises a separate vessel or structure having energy storage capabilities for electric power, hydrogen, and fuel cells to enable continuous generation during operation of said power generating system, said vessel may transit to remote location for offloading said energy storage capabilities.

9. The system of claim 2, comprising said power generating system generates power utilizing the carbon chain to mitigate the atmospheric release of carbon dioxide by sequestration and upgrading to products.

10. The system of claim 1, further comprising recycle off gases and or waste steam for regeneration of steam, comprising:
a heat recovery steam generator; steam is supplied to a steam turbine; and
a driver powered by a steam turbine, said driver being connected to;
an electric power generator.

11. The system of claim 1, wherein said sequestration system may include other types of electrolyzer, or combinations thereof, comprising:
a solid oxide electrolyzer; and or
a solid acid electrolysis cell.

12. The system of claim 1, wherein said storage and offloading system may include delivery mechanisms using drone technologies for delivery of said products to remote locations, comprising:
Hydrogen Fuel Cells; and or
Electric Fuel Cells.

13. A method for carbon dioxide upgrading, comprising:
an oceanic offshore structure;
an AC/DC convertor mounted on said oceanic offshore structure wherein said convertor is connected to the onboard electric power generating system; and
a seawater filtration system mounted on said ocean offshore structure, wherein includes separation and enrichment systems for filtered seawater; and
a sequestration system mounted on said ocean offshore structure, comprising a Heat Recovery Steam Generator, said Heat Recovery Steam Generator being connected to an Intermediate Temperature Steam Electrolyzer, wherein carbon dioxide combustion gases from said power generation system and said filtered seawater are processed to create feedstocks for syngas, and
a production system mounted on said ocean offshore structure, wherein said production system being connected to said sequestration system for transfer of said syngas to a Fischer-Tropsch Synthesis process for conversion to synthetic crude, and
a product upgrading system mounted on said ocean offshore structure, wherein said product upgrading system being connected to said production system for transfer of said synthetic crude to a product upgrading process for conversion to liquid and gaseous fuel products; and
a storage and offloading system, mounted on said ocean offshore structure for distribution of said products to a remote location.

14. A method for generating electric power and carbon dioxide upgrading, comprising:
an oceanic offshore structure;
a gas processing and optimization module mounted on said ocean offshore structure, wherein said gas optimization module includes separation and enrichment systems; and
an electric power generating system mounted on said oceanic offshore structure, said electric power generating system including:
an electric power generator;
a driver powered by a combustion process of a fossil fuel source, said driver being connected to said generator;
an electric power transmission system to transfer electricity from said generator to a remote location; and
a capture system connected to said driver for capturing combustion gasses transferred from said combustion process, said capture system comprising:
a flue gas separation station for separating the carbon dioxide from non-carbon dioxide combustion gases by absorption, adsorption, or membrane gas separation, prior to transferring said carbon dioxide to an onboard sequestration system Intermediate Temperature Steam Electrolyzer with the non-carbon dioxide gas transferred to an onboard sequestration system Heat Recovery Steam Generator; and
an AC/DC convertor mounted on said oceanic offshore structure wherein said convertor is connected to said electric power generating system; and
a seawater filtration system mounted on said ocean offshore structure, wherein includes separation and enrichment systems for filtered seawater; and
a sequestration system mounted on said ocean offshore structure, comprising a Heat Recovery Steam Generator, said Heat Recovery Steam Generator being connected to an Intermediate Temperature Steam Electrolyzer, wherein carbon dioxide combustion gases from said power generation system and said filtered seawater are processed to create feedstocks for syngas, and
a production system mounted on said ocean offshore structure, wherein said production system being connected to said sequestration system for transfer of said syngas to a Fischer-Tropsch Synthesis process for conversion to synthetic crude, and
a product upgrading system mounted on said ocean offshore structure, wherein said product upgrading system being connected to said production system for transfer of said synthetic crude to a product upgrading process for conversion to liquid and gaseous fuel products; and
a storage and offloading system, mounted on said ocean offshore structure for distribution of said products to a remote location.

15. The method of claim 14, wherein said oceanic offshore structure is fixed or floating.

16. The method of claim 14, wherein said fossil fuel source is supplied to said gas processing and optimization module on said oceanic offshore structure by a line connected to either:
a conduit connected to a seabed pipeline; or
a gas storage tank connected by a conduit to a seabed pipeline; or
storage vessels connected by a line to a barge or ship.

17. The method of claim 14, wherein said driver is gas combustion turbines, or combination of gas and steam turbines, or LNG turbines with fuel injection, or combination of LNG turbines with fuel injection and steam turbines.

18. The method of claim 14, wherein said oceanic offshore structure can disconnect fuel and transmission system connections for transit to a different location.

19. The method of claim 14, wherein said power generating system provides base load power generation to said remote location.

20. The method of claim 14, wherein said power generating system comprises a separate vessel or structure having energy storage capabilities for electric power, hydrogen, and fuel cells to enable continuous generation during operation of said power generating system, said vessel may transit to remote location for offloading said energy storage capabilities.

21. The method of claim 14, comprising said power generating system generates power utilizing the carbon chain to mitigate the atmospheric release of carbon dioxide by sequestration and upgrading to products.

22. The method of claim 13, further comprising recycle off gases and or waste steam for regeneration of steam, comprising:
a heat recovery steam generator; steam is supplied to a steam turbine; and
a driver powered by a steam turbine, said driver being connected to;
an electric power generator.

23. The method of claim 13, wherein said sequestration system may include other types of electrolyzer, or combinations thereof, comprising:
a solid oxide electrolyzer; and or a solid acid electrolysis cell.

24. The method of claim 13, wherein said storage and offloading system may include delivery mechanisms using drone technologies for delivery of said products to remote locations, comprising:
Hydrogen Fuel Cells; and or Electric Fuel Cells.

25. A product HydroDiesel made by the process of claim 1.
